(19) United States
(12) Patent Application Publication
(10) Pub. No.: US 2016/0027072 A1
(43) Pub. Date: Jan. 28, 2016

(54) INTEGRATED MECHANISM FOR SHARING INDIVIDUAL DATA TO A CENTRAL SYSTEM AND SOCIAL NETWORKS

(71) Applicant: POSIBA, INC., San Diego, CA (US)

(72) Inventors: Elizabeth S. Dreicer, San Diego, CA (US); Anders Olsson, San Diego, CA (US)

(21) Appl. No.: 14/806,535

(22) Filed: Jul. 22, 2015

Related U.S. Application Data
(60) Provisional application No. 62/027,738, filed on Jul. 22, 2014.

(51) Int. Cl. G06Q 30/02; G06Q 50/00; H04L 29/08

(52) U.S. Cl. CPC G06Q 30/0279; H04L 67/10; G06Q 50/01

(57) ABSTRACT

A data processing system is disclosed that includes a social network user account operating on a social network, wherein the social network user account includes user data that uniquely identifies a user and associated algorithmic functionality uniquely associated with the user, and the social network includes a plurality of server systems that are configured to execute the algorithmic functionality uniquely associated with the user on demand. A charitable website independent from the social network and configured to provide data to a web browser system in response to a request from the user. A graphic user interface control operating in conjunction with the charitable website and having associated functionality for correlating a donation to the charitable website with the social network user account.

### RELATED APPLICATIONS

The present application claims priority to U.S. Provisional Patent Application No. 62/027,738, filed on Jul. 22, 2014, which is hereby incorporated by reference for all purposes as if set forth herein in its entirety.

### TECHNICAL FIELD

The present disclosure relates generally to data processing, and more specifically to an integrated mechanism for sharing data relating to individual donations to a central system and to various social networks.

### BACKGROUND OF THE INVENTION

Currently there is no intelligence or transparency into the individual giving to the charitable sector. As such, little can be learned about where money is going, when and why. Even more importantly, experts lack critical data points that would potentially allow them to correlate timely giving data with outcomes on the ground. In addition, individual charitable giving goes largely unrecognized by the community at large, and as such it remains isolated in its overall impact to the specific recipient or the sector as a whole.

### SUMMARY OF THE INVENTION

A data processing system is disclosed that includes a social network user account operating on a social network, wherein the social network user account includes user data that uniquely identifies a user and associated algorithmic functionality uniquely associated with the user, and the social network includes a plurality of server systems that are configured to execute the algorithmic functionality uniquely associated with the user on demand. A charitable website independent from the social network and configured to provide data to a web browser system in response to a request from the user. A graphic user interface control operating in conjunction with the charitable website and having associated functionality for correlating a donation to the charitable website with the social network user account.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing an integrated mechanism for sharing individual data to a central system and social networks, in accordance with an exemplary embodiment of the present disclosure;

FIG. 2 is a diagram of a system for providing social network account functionality, in accordance with an exemplary embodiment of the present disclosure;

FIG. 3 is a diagram of a system for sharing data between systems in accordance with an exemplary embodiment of the present disclosure; and

FIG. 4 is a diagram of an algorithm in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Prior to the implementation of the present disclosure, there was no integrated system that combines donation reporting in a central repository system with social network integration for sharing data using algorithmic data processing. Data management systems such as donor management and CRM software currently perform the function of collecting donation data and aggregating it. Unlike the present disclosure, however, these data management systems maintain the data on a one-off basis, such that no aggregation, and therefore meaningful reporting for the sector, can be achieved.

Separately, individual charities can utilize social media integration on their websites, such that an individual donor may us a social media control such as a “like” control to share a charity's webpage to the other social media network users that form the donor's social media network. However, these current solutions require that the donor to permit each individual charity to have access to their social media profiles. Additionally, because of the fragmentation of how charitable contributions are shared on social networks, there is no ability for users to see the total impact they may have had through the original donation and the fact that they invited their network to contribute.

In one exemplary embodiment of the present disclosure, a user may want to help Charity A raise money for a program it operates. The user donates $100 to Charity A, which has placed the necessary code on its website to be a part of the social media network. The user “shares” her donation to her social media network contacts through the social media network integration capability of the system. The user wants to know the total impact of her donation and opts to “follow” her donation's total impact over time. An algorithmic function of the present disclosure tracks the total donations to Charity A that results from the original donation/sharing by counting all donations that were given after:

a selection of a control from the social media network data posting of the original user;

a selection of a control from the social media network data posting of subsequent users in the social media network contacts of the original user (first derivative);

a selection of a control from the social media network data posting of subsequent users in the social media network contacts of the first derivative users (second derivative); or other suitable interactions. A visual display/graphic user interface provides the user with up-to-date information on total donations given by first derivative users, second derivative users and so forth. The user can re-post the original donation post to her social network profile, can post a new post that shows the latest total impact statistics related to the original donation to encourage even more people to contribute to Charity A, or can perform other suitable functions.

In another exemplary embodiment, Charity A has implemented algorithmic functions from the present disclosure using its website and therefore participates in the data sharing with a related data sharing mechanism. The data sharing mechanism uses algorithmic processes to identify and store key data elements from individual donation transactions, such as a donation date, a donation amount, a recipient of the donation and other suitable data, and that data to a centralized repository for donation data, such as a relational database that can be used for the disclosed functions. In this example, Charity A is a critical service provider in the area of maternal health in Kansas City, Mo. Foundation A is a charitable foundation that has historically provided funds to support maternal health in the state of Missouri. Foundation A may use the disclosed functionality to more effectively distribute its limited annual budget between all charities in the state that are focused on improving maternal health.

In this example, Charity A might experience a slow-down in individual donations through its website due to a local economic conditions. Foundation A may use the system to compare the shortfall of individual donations of Charity A to that of other charities participating in the system and focused on maternal health in the state of Missouri. If deemed appropriate and in light of the information gathered through the user interface of the reporting mechanism of the system, Foundation A may increase the annual funding to Charity A or approve an emergency grant to cover up the short-fall, either at the expense of other charities that have not experienced a drop in their intake of individual donations, or in addition to the budgeted amount of annual grant making by the Foundation.

The present disclosure contemplates a donor control to provide the function for fundraisers on the web to leverage the disclosed system for mutual advantage. The donor control can be implemented as an object having associated text, functional and graphic data, such as HTML code for insertion of the control on a fundraising web site. The functional code of the donor control can interact with an applications programming interface (API) of a centralized or distributed data sharing system using data messaging or in other suitable manners.

In one exemplary embodiment, the donor control does not perform donation-related data processing by itself, and instead only performs selected functions, such as 1) recording data pertaining to the amount of the donation, 2) recording the date and time of the donation, 3) recording the relationship between the donor and the receiving organization, 4) providing data-sharing access for the donor to social networks or other suitable systems, and other suitable functions.

While the donor control can be generated when a donation has taken place, and an amount of the donation is available, there is no restriction on when it can be generated. For example, the donor control can be implemented in conjunction with a Paypal™ donation control, a credit card donation control, or donation controls for other suitable payment networks, as described in greater detail herein.

A fundraising organization benefits from the disclosed donor control by allowing it to offer the disclosed service to their contributors, and to offer public recognition of the contribution via social media. The disclosed service makes it easy for the donor to opt-in to social media postings on three different feeds: for a posting on a personal account, for a posting on an account of the fundraising organization, and for a posting with the disclosed service itself.

The donor control implements a network effect in donations to the organization. By alerting social media that a “friend” has made a donation, other donations from other prospective donors can be solicited in a manner that is more effective than impersonal advertisements or other similar solicitations. The donor control can also facilitate sharing data relating to the entity and its own social media pages.

A second network effect is that the donors themselves who take advantage of the disclosed service can be reminded of their donation, and will have a chance to see the results of sharing data regarding the donation, such as in terms of subsequent donations made by others, by outcomes achieved or in other suitable manners. The donor control provides the fundraising organization with a mechanism to engage the donor in ongoing interactions, which will help to drive more donations.

The donor also benefits from use of the donor control. The donor can set up an account with the disclosed service and can gain access to the public tier of the disclosed system, with their donation and supported entity already recorded. The donor can also elect to see their contribution recognized on social media of the disclosed system, either anonymously or by name. The disclosed system uses each entity's social media credentials to publish to a data feed for that entity, the user's permission from log-in for publishing to the user's data feed, and its own social credential to publish to its own data feed, where a data feed can be information that is periodically or continuously provided by an entity for the benefit of others. In addition to Facebook style postings, the system can also publish its own Twitter feed, tagging the donor as appropriate where the donor's information is available.

The disclosed system can gather data from the use of the donor control to generate information about contributions, users, and entities. Even anonymous contributions can be used by the disclosed system to record the receipt of the donation to the entity.

A subset of the donor control is the API. This API allows the reporting of contributions from donors to charitable entities at the time of the donation. It can also be used with a donation of $0.00 in order to create a relationship between the donor and the entity. When the user presses the donor control a number of things happen. From the webpage developer's point of view, the disclosed system has provided a code snippet that is inserted in their webpage design at the point and location where they would like the donor control to appear. By activating the donor control, the user is invoking code that executes on associated servers. Paypal and other affiliated payment functions build a specific encrypted argument that identifies the account to which their payment will be posted, and the API likewise identified associated accounts. Other arguments could be passed in the initial transaction such as the amount of the donation and the identity of the user, which can be implemented using coding in the user's web site or in other suitable manners.

After user activation of the donor control, the disclosed system can extract enough information to generate indications that that a donation has been made to the entity, and interact with the user. The disclosed system can display a popup window in response to activation of the donor control. The window can generate a display an acknowledgement and thanks for the donation (if amount is provided and not zero) and the logo of the entity so that a connection is maintained between the disclosed system and the entity. The popup can include a privacy checkbox, so that the user can elect not to share the donation with others (although the disclosed system will already register that a donation has been made). In addition, the user will be given the opportunity to “join” an account associated with the disclosed system, such as by using a Facebook login or in other suitable manners. A third case, where the user already has an accounting with the disclosed system, can also be acknowledged, in this case the user might already be logged in, or might be recognized by a cookie on their computer.

The disclosed system can obtain additional information about the donor, such as categories (social causes) of interest. Gathering this information can be implemented using a profile page of the disclosed system for the user's account. In addition, the disclosed system can infer categories from the relationship that is established between the user and the entity.

In another exemplary embodiment, a window can be displayed in response to activation of the donor control. Once the user is logged into the disclosed system, they can default to a page of the disclosed system that shows the entity they just donated to, their donation on the entity graph (when it is available, and reasonable data has been uploaded so the display is meaningful), and other suitable data. At this point, the disclosed system has obtained:

1. Information that a donation has been made to the entity.
2. Information about the amount of the donation, if it is provided by the entity's website.
3. Basic information about the user that can be obtained from the webserver as the popup window is displayed, such as an IP address, a browser type, an estimated physical location and so forth.
4. Privacy requests if any from the pop-up window.
5. A Facebook profile, friend list, and permission to post on the user's timeline if the user logs in through Facebook and gives permission.
6. The disclosed system's own account information and user profile if the user sets up a new account.
7. A new user.

Based on the information obtained, the disclosed system can carry out the Social media postings as authorized. The system can post to Twitter with hashtags and identities where known. If permissions have been granted, the system can make a posting to the user's timeline indicating both the receiving entity and the disclosed system's own branding. Similar posting can be made to the Entity timeline and the disclosed system's timeline, subject to privacy selections.

Facebook login can be used to manage user accounts that are created through activation of the donor control. Facebook login uses a Javascript SDK to check login status, authorize users, log-in, and log-out. The donor control can be used by users when there is an already established relationship between the Charitable entity and the disclosed system. There can also be a functional public tier of membership in the disclosed system and the information in the disclosed system, which needs to be extensive enough to offer a good value for the time spent interacting with the disclosed system.

The donor control can be offered to non-profits and other organizations that are either clients of the disclosed system operator, or related to clients. The donor control can be used to offer when the disclosed system has accumulated a reasonable amount of information about the entity and the landscape. The disclosed system can establish necessary functionality on Facebook.

In various exemplary embodiments, users manage user authorization, authentication, roles and privileges as well as providing the external interface to the users themselves. Entities include organizations and institutions that the disclosed system gathers, tracks, and maintains information about. A repository includes the database of the disclosed system, or one that contains information about entities in terms of the dictionary.

Exemplary functionality associated with the control can include: 1) use by fundraisers after a donation has been made; 2) making a record of a donation; 3) allowing a fundraiser to easily show a donor control on their website; 4) acquire basic information from a single act of actuating the control; 5) displaying a thank you and offering additional options to the user; 6) offer users an opportunity to set up an account on the system; 7) offers users an opportunity to set privacy pptions; 8) acquire data regarding the user, entity, and amount; 9) establish a relationship recorded in the repository between the user and the entity; 10) uses Facebook or other social network login data; 11) make a social media posting on behalf of a user or other entity, and other suitable functions.

FIG. 1 is a diagram of a system 100 for providing an integrated mechanism for sharing individual data to a central system and social networks, in accordance with an exemplary embodiment of the present disclosure. System 100 can be implemented in hardware or a suitable combination of hardware and software, and includes social network 102, data sharing mechanism 104, social network accounts 106A through 106N, controls 108A through 108N, integrator 110, charitable websites 112A through 112N, payment processing system 114, network 116 and user devices 118A through 118N. In one exemplary embodiment, a user can access the user's social network account 106A through 106N, a charitable website 112A through 112N, data sharing mechanism 104, payment processing system 114 and other suitable systems and devices through a user device 118A through 118N operating a web browser or other suitable access systems.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Social network 102 is a network of computers that provides services to users and allows them to interact with each other in accordance with predetermined mechanisms. In one exemplary embodiment, social network 102 can include a plurality of distributed servers, memory devices, communication devices and other suitable devices that allow individuals and organizations to communicate with each other. Although a single social network 102 is shown, a suitable number of social networks can be used as discussed herein, and the present disclosure is not limited to a single social network implementation.

Data sharing mechanism 104 is configured to interface with social network 102, charitable websites 112A through 112N, payment processing system 114 and other suitable systems. In one exemplary embodiment, data sharing mechanism can include a plurality of algorithms that are configured to interface with applications programming interfaces of social network 102, charitable websites 112A through 112N, payment processing system 114 and other suitable systems at predetermined times and in response to predetermined messages received over network 116, as described further herein. Although data sharing mechanism 104 is shown as being external to social network 102, it can be included within social network 102 or another social network, or can be a separate social network or other suitable systems.

Social network accounts 106A through 106N are separate social network accounts that are owned by and operated by specific individuals or organizations, including but not limited to charitable organizations, not-for-profit organizations, foundations, fraternal organizations, service organizations, or businesses. In one exemplary embodiment, a social network account can be configured to allow an individual or organization generate content in predetermined formats, to communicate with other social network accounts, to insert content from sources outside of the social network and to perform other suitable functions.

Controls 108A through 108N are configured to allow users of social network 102 to share contributions that are made to charitable websites 112A through 112N, respectively. In one exemplary embodiment, controls 108A through 108N are provided by charitable websites 112A through 112N through a graphic user interface that allows a user to provide information needed to donate money to the charitable organization, such as through payment processing system 114. In another exemplary embodiment, data sharing mechanism 104 can include control 108B, and can display control 108B in conjunction with information about a charity (such as on a web page for the charity or on an account page for the charity), information about a user (such as on a user-created portfolio page) or in other suitable manners.

Integrator 110 provides user functionality for social network accounts 106A through 106N to allow them to access data sharing mechanism 104 and to data sharing mechanism 104 to obtain data about social network accounts 106A through 106N and to provide information to social network accounts 106A through 106N. In one exemplary embodiment, integrator 110 can include an applications programming interface (API) that defines the data formats, variable names and other suitable data that can be provided to third party systems from social network accounts 106A through 106N, and that allows third party systems to provide data to social network accounts 106A through 106N.

Charitable websites 112A through 112N can be separately-hosted websites for different charities, which can be configured to operate independently of each other and social network 102, but which are configured to interface with data sharing mechanism 104 through controls 108A through 108N, and with payment processing system 114, to receive payments from third parties.

Payment processing system 114 is configured to allow third parties to send funds to other third parties. In one exemplary embodiment, payment processing system can be configured to use the credit or debit networks or other suitable payment networks to allow users to submit data in a suitable format that identifies a payment account, a payment network, a payment amount, a payment schedule or other suitable payment data. Payment processing system 114 can generate user interface controls on charitable websites 112A through 112N, on data sharing mechanism 104, on graphic user interfaces of social network accounts 108A through 108N or in other suitable user interfaces.

Network 116 can be a wireline network, a wireless network, an optical network, a virtual network, other suitable networks or a suitable combination of networks.

User devices 118A through 118N can be desktop computers, tablet computers, notebook computers, wireless devices, smart phones or other suitable devices that operate web browser systems, software applications, thin client systems or other suitable systems or devices.

In operation, system 100 allows a social network account user to access a charitable website that provides a payment mechanism, and to elect to have their contribution tracked and shared to other social network users by selecting a single control 108. A data sharing mechanism 104 coordinates the transfer of data between the social network user and other social network users, tracks related donations and statistics, and performs other suitable functions as discussed herein.

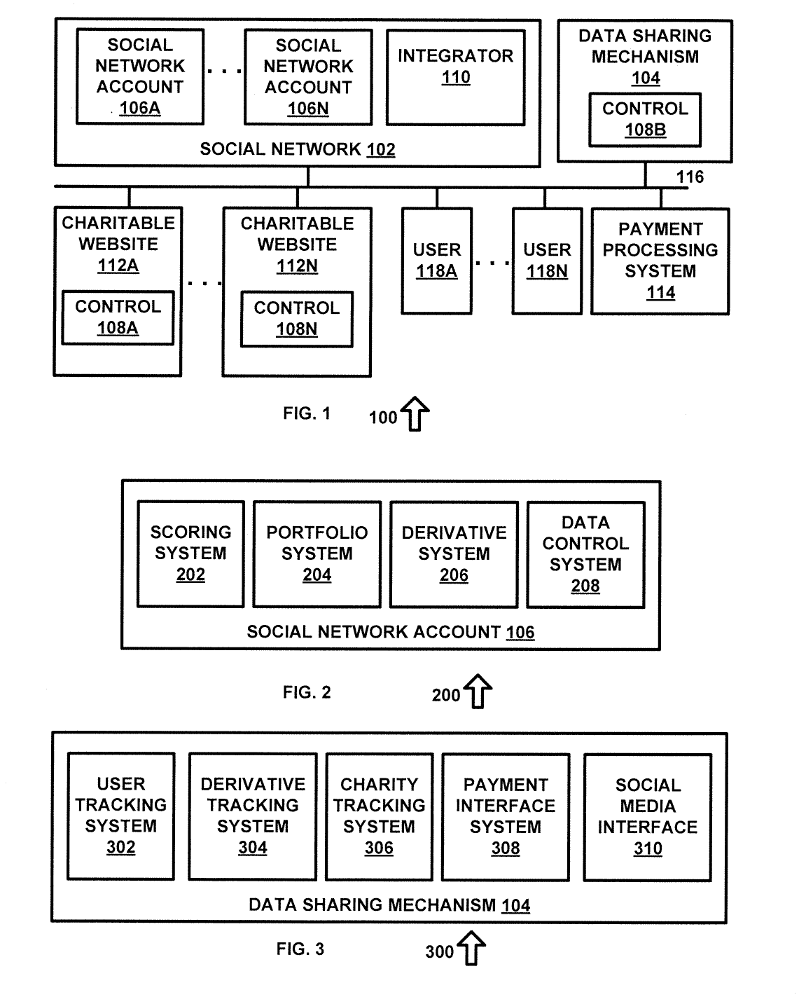

FIG. 2 is a diagram of a system 200 for providing social network account functionality, in accordance with an exemplary embodiment of the present disclosure. System 200 includes social network account 106 and scoring system 202, portfolio system 204, derivative system 206 and data control system 208, each of which can be implemented in hardware or a suitable combination of hardware and software.

Scoring system 202 generates scoring data for a social network account. In one exemplary embodiment, scoring system can implement one or more algorithms that generate scoring data, such as an algorithm that obtains contribution data for a user and generates a score relative to other users (such as by totaling the contribution data and ranking the total for the user relative to other users), an algorithm that obtains contribution data for other social network account users that endorsed a contribution by the user (such as by totaling all contributions from derivative contributors, as discussed herein and by ranking the total relative to other users), or other suitable algorithms.

Portfolio system 204 generates and tracks portfolio data for a social network account user. In one exemplary embodiment, portfolio system 204 tracks charitable contribution data for each a plurality of social network users, allows a user to create a group of charitable organizations that can be funded by a single donation, allows a user to share data related to a charitable organization that defines the activities of the charitable organization and performs other suitable functions.

Derivative system 206 allows a social network user to see the effectiveness of notifications provided to others regarding charitable organizations by tracking funding, time spent or other suitable metrics. In one exemplary embodiment, a social network account user can send notifications to other social network account users by using a control 108 or other suitable functions, to provide predetermined data to the other social network account users, such as information describing a charitable organization, information describing the accomplishments of the charitable organization, information pertaining to an event of the charitable organization, information pertaining to the user's contributions to a charitable organization or other suitable data. In response, the recipients of such information can elect to donate funds or time to the charitable organization, can forward the information from the first user to other users or can perform other suitable functions. In this manner, a first user can create a number of first derivative users, who can then create second derivative users and so forth. Derivative system 206 tracks the first derivative users, the second derivative users and other suitable users for each of a plurality of social network account users, such as to allow the social network account user to determine the effectiveness of their efforts to convince others of the importance or effectiveness of a charitable organization or for other suitable purposes.

By way of example and not by limitation, examples of the relationship between 1) users and 2) their first derivative users can include: 1) individuals and 2) their social media friends; 1) charitable organizations and 2) their volunteers; 1) businesses and 2) employees. The first derivative relationship is thus not limited to social media relationships, and can include relationships that are also reflected in private networks or other data systems.

Data control system 208 generates one or more user interface controls that allow a user to define the amount of information that will be shared. In one exemplary embodiment, the user can select a control that allows the amounts of money, time, organization names or other data relating to the charitable organizations that the user contributes to be shared with or without user-specific information, to any requester or to predetermined groups of requesters (e.g. to friends, to data sharing mechanism).

FIG. 3 is a diagram of a system 300 for sharing data between systems in accordance with an exemplary embodiment of the present disclosure. System 300 includes data sharing mechanism 104 and user tracking system 302, derivative tracking system 304, charity tracking system 306, payment interface system 308 and social media interface 310, each of which can be implemented in hardware or a suitable combination of hardware and software.

User tracking system 302 utilizes one or more algorithms to verify a location of a user. In one exemplary embodiment, an algorithm can receive event location data for an event from a charitable website or other event organizers, where the event has a plurality of volunteers, and a social media user can sign up to volunteer for the event through user tracking system 302 by providing account identifying data, such as by accessing user tracking system 302 and providing identifying information. When the social media user is at the event, they can sign in to the event at an event portal that has access to user tracking system 302, with a personal communications device that has access to data sharing mechanism over network 116, or in other suitable manners. The user can also enable positional tracking, such as by using GPS data of a user's personal communications device, to allow the user to be automatically signed up or checked in for the event, to allow the length of time that the user was at the event to be tracked, or for other suitable purposes. In another exemplary embodiment, the user can be given instructions to compete in the event based on location data, can be matched with tasks that require volunteer assistance based on location, or can otherwise use location data for event functions. In this exemplary embodiment, the algorithm can generate a plurality of locations that are associated with functions, and users can be selected for a function based on their location, on registration data that includes a preference ranking for available functions, or in other suitable manners.

Derivative tracking system 304 provides derivative tracking data for users. In one exemplary embodiment, when a user transmits notification data to other social media network users of a charity or event, the transmission can be accomplished by going through derivative tracking system 304, which can utilize one or more algorithms that receive the notification and associated address data and which stores user identification data, notification data and recipient data in a relational database structure, so as to allow the recipients of the notification data to be logged and tracked. Metadata contained within the notification data can be identified, stored and used to track whether a recipient forwards the notification to others, generates a new set of notification data or takes other suitable actions, using one or more algorithms that locate the metadata in predetermined data fields, such as by comparing the data fields to data having a predetermined format, a user identifier or other suitable data. In this manner, second degree contacts, third degree contacts and other suitable relationships between users can be determined, such as to allow users that are effective at recruiting others to be identified and rewarded or recognized.

Charity tracking system 306 utilizes one or more algorithms to track donors to charities. In one exemplary embodiment, donors can be prompted to provide identifying data and permission to share the data with a charity when they make a donation, volunteer for an event or otherwise interact with the charity, and the identifying data can be stored in a relational database with associated data that identifies whether the donor provided money, in kind goods, time, or other suitable data. In one exemplary embodiment, the data can include affiliations that the user has with the charity, such as family members that receive help from the charity, professional affiliations related to the charity or other suitable data. Charity tracking system 306 can also be used by the charity or others to identify donors for events, donors having special skills, donors having special interests or other suitable donors.

Payment interface system 308 provides one or more algorithms for processing payment data associated with charitable donations. In one exemplary embodiment, a control such as control 108 can be used in conjunction with a payment processing system, such as to include data transmission and messaging algorithms that request predetermined authorized data from the payment processing system, such as a confirmation of an amount that was donated, a confirmation of a recipient or other suitable data. Due to payment processor security, payment interface system 308 might be prevented from access payment data directly, but can include preauthorization processing algorithms, secured key processing algorithms or other suitable processes to request additional data associated with a charitable contribution.

Social media interface 310 stores social media network API data and utilizes associated algorithms to transmit data to and receive data from social media networks, to generate notification data for posting within social media networks and for other suitable functions. In one exemplary embodiment, a social media network can publish its API for use by third parties, such as subject to registration, verification or other suitable processes, and can also publish format data for use in generating billboards, notifications, advertising or other suitable data sharing processes within a social media network. In one exemplary embodiment, a social media network user may want to post a notice within the user's social media network account that shows the total amount of money donated to a charitable event, and where the social media network has predetermined formats for providing such data and for receiving updates to fields within such notifications. Social media network 310 stores the data formats, data communications protocols and associated algorithms to allow users to utilize social media network functionality in conjunction with the data stored and tracked by system 300.

In operation, system 300 allows a user to access data functions related to charitable donations made by the user, such as tracking of money or time donated by the user, tracking of affiliates that have been notified of charitable causes by the user and other suitable functions.

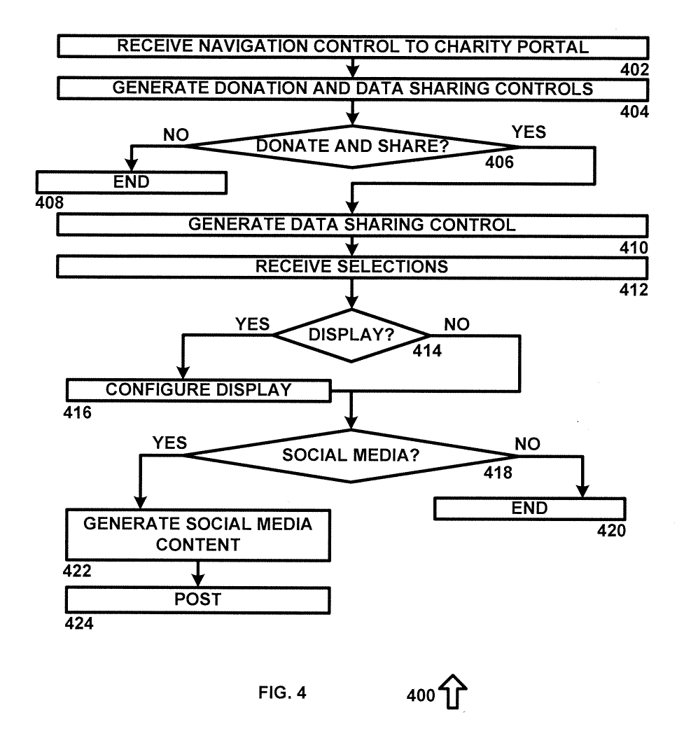

FIG. 4 is a diagram of an algorithm 400 in accordance with an exemplary embodiment of the present disclosure. Algorithm 400 can be implemented in hardware or a suitable combination of hardware and software. Although algorithm 400 is shown as a flow chart, it can be implemented using object oriented programming, state diagrams or in other suitable manners using other suitable programming paradigms.

Algorithm 400 begins at 402, where a navigation control to a charity portal is received. In one exemplary embodiment, the navigation control can be associated with a control that allows a user to share donation data when the donation is being made, such as by interfacing with a payment application to obtain confirmation data of a contribution to a charity, by receiving time tracking data associated with a user that identifies when a user checked into a charity event, or other suitable data. The algorithm then proceeds to 404.

At 404, donation and data sharing controls are generated. In one exemplary embodiment, the donation and data sharing controls can include one or more user interface controls that allow the user to select the amount of data that will be shared regarding the donation, such as to allow the user's identity to be associated with the date and amount donated, to restrict the date or amount from being shared, to allow the data to be shared with predetermined organizations or individuals, to allow the user to opt in to or to opt out of predetermined data sharing functions or for other suitable purposes. The algorithm then proceeds to 406.

At 406, it is determined whether the user has donated and elected to share data about the donation. If the user elects not to donate or share data, the algorithm proceeds to 4-8 and ends, otherwise the algorithm proceeds to 410 generate social media network selection controls. In one exemplary embodiment, one or more social media networks can each have APIs and functions that are used for posting data to the social media network, and user interface controls can be generated to allow the user to select the social media networks that the user wants to share data on. The algorithm then proceeds to 412.

At 412, user selections are received, such as receiving user interface icon activation controls, by retrieving stored social media user account data for the user, by prompting the user to enter social media account data and storing the social media account data, or in other suitable manners. The algorithm then proceeds to 414.

At 414, it is determined whether the user has selected a display control. If no display control has been selected, the algorithm proceeds to 418, otherwise the algorithm proceeds to 416 where one or more display controls are generated and selected. In one exemplary embodiment, the user can select a display control to generate a display showing all of the user's charitable contributions to a charity, to a group of charities, over a predetermined time period, to include derivative donations or to include other suitable data, where selection of the controls causes format data to be generated in a data message that is processed by a data sharing mechanism to generate a report with the selected data. In another exemplary embodiment, the user can select data to be generated in a post for social media, or other suitable displays. The algorithm then proceeds to 418.

At 418, it is determined whether the user selected a control to generate a social media posting. If no social media posting control was selected, the algorithm proceeds to 420 and terminates, otherwise the algorithm proceeds to 422 where the selected social media content is generated, and then to 424 where the content is posted.

In operation, algorithm 400 allows a user to elect to share charitable donation data with others, and further provides additional controls regarding the amount of data to be shared and the channels through which the data is to be shared.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A data processing system comprising:
a social network user account operating on a social network computing system, wherein the social network user account includes user data that uniquely identifies a user and associated algorithmic functionality uniquely associated with the user, and the social network includes a plurality of server systems that are configured to execute the algorithmic functionality uniquely associated with the user on demand;
a charitable website independent from the social network and configured to provide data to a web browser system in response to a request from the user; and
a graphic user interface control operating in conjunction with the charitable website and having associated functionality for correlating a donation to the charitable website with the social network user account.

2. The data processing system of claim 1 further comprising a data sharing mechanism operating on a processor and remote from the social network user account and the charitable website, the data sharing mechanism configured to provide an interface between the social network user account and the charitable website.

3. The data processing system of claim 1 further comprising a scoring system operating in conjunction with the social network user account and configured to receive data identifying the donation to the charitable website and to generate a score associated with the donation.

4. The data processing system of claim 3 further comprising a portfolio system operating in conjunction with the social network user account and configured to receive data identifying the donation to the charitable website and to generate a portfolio user interface showing the donation and additional donations to other charitable websites made by the user, and wherein the scoring system is configured to generate the score as a function of the donation and the additional donations.

5. The data processing system of claim 1 further comprising a derivative system configured to receive data identifying one or more additional users that receive data identifying the donation and to track donations made by the one or more additional users.

6. The data processing system of claim 1 further comprising a user tracking system configured to receive location for the user and to authenticate a location of the user during an event.

7. The data processing system of claim 1 further comprising a derivative tracking system configured to receive data identifying one or more second degree users that receive data identifying a donation made by one of the additional users and to track donations made by the one or more second degree users.

8. The data processing system of claim 1 further comprising a charity tracking system configured to receive data identifying all donations received by a charity and to generate donor data associated with the donations.

9. The data processing system of claim 1 further comprising a payment interface system configured to generate a payment control associated with the charitable website and to transmit data authenticating a donation to a data sharing mechanism.

10. The data processing system of claim 1 further comprising a social media interface system configured to receive data from the social network user account and the charitable website and to generate a social media posting as a function of the received data.

11. A data processing system comprising:
a social network user account operating on a social network computing system, wherein the social network user account includes user data that uniquely identifies a user and associated algorithmic functionality uniquely associated with the user, and the social network includes a plurality of server systems that are configured to execute the algorithmic functionality uniquely associated with the user on demand;
a charitable website independent from the social network and configured to provide data to a web browser system in response to a request from the user;
a graphic user interface control operating in conjunction with the charitable website and having associated functionality for correlating a donation to the charitable website with the social network user account;
a data sharing mechanism operating on a processor and remote from the social network user account and the charitable website, the data sharing mechanism configured to provide an interface between the social network user account and the charitable website;
a scoring system operating in conjunction with the social network user account and configured to receive data identifying the donation to the charitable website and to generate a score associated with the donation;
a portfolio system operating in conjunction with the social network user account and configured to receive data identifying the donation to the charitable website and to generate a portfolio user interface showing the donation and additional donations to other charitable websites made by the user, and wherein the scoring system is configured to generate the score as a function of the donation and the additional donations;
a derivative system configured to receive data identifying one or more additional users that receive data identifying the donation and to track donations made by the one or more additional users;
a user tracking system configured to receive location for the user and to authenticate a location of the user during an event;
a derivative tracking system configured to receive data identifying one or more second degree users that receive data identifying a donation made by one of the additional users and to track donations made by the one or more second degree users;
a charity tracking system configured to receive data identifying all donations received by a charity and to generate donor data associated with the donations;
a payment interface system configured to generate a payment control associated with the charitable website and to transmit data authenticating a donation to a data sharing mechanism; and
a social media interface system configured to receive data from the social network user account and the charitable website and to generate a social media posting as a function of the received data.
